(19) United States
(12) Patent Application Publication
(10) Pub. No.: US 2025/0065244 A1
(43) Pub. Date: Feb. 27, 2025

(54) LIQUID DISTRIBUTOR

(71) Applicant: L'Air Liquide, Societe Anonyme pour l'Etude et l’Exploitation des Procedes Georges Claude, Paris (FR)

(72) Inventor: Mikael WATTIAU, Jouy-en-Josas (FR)

(73) Assignee: L'Air Liquide, Societe Anonyme pour l'Etude et l’Exploitation des Procedes Georges Claude, Paris (FR)

(21) Appl. No.: 18/813,721

(22) Filed: Aug. 23, 2024

(30) Foreign Application Priority Data
Aug. 23, 2023 (FR) FR 2308860

(51) Int. Cl. B01D 3/00; B01J 19/32

(52) U.S. Cl. CPC B01D 3/008; B01J 19/32; B01J 2219/3221; B01J 2219/32213

(57) ABSTRACT

A gravity liquid distributor a having a lower plate provided with orifices via which a liquid leaves the distributor in order to irrigate a lower element. Parallel parallelepipedal chimneys dedicated to the passage of the ascending gas. The chimneys are distributed over an entire central portion with a circular cross section of the lower plate, which frees up a peripheral channel, which is fluidically connected to the troughs, over the perimeter of the lower plate. A plurality of hats that are able to guide the liquid collected above the troughs towards the peripheral channel, each hat having an elongate rectangular form with two ends, with just one hat per trough, the hat being closed off at just one end such that at least the majority of the liquid collected flows towards the peripheral channel. The hats are oriented at an acute or zero angle with respect to the horizontal.

### CROSS-REFERENCE TO RELATED APPLICATIONS

This application claims the benefit of priority under 35 U.S.C. § 119 (a) and (b) to French patent application No. FR 2308860, filed Aug. 23, 2023, the entire contents of which are incorporated herein by reference.

### BACKGROUND

The present invention relates to the field of equipment for contacting fluids. Columns or towers for contacting gas/liquid sometimes use packings to improve the heat and mass exchanges between a liquid and a gas. These columns are commonly used for heat transfer, distillation, absorption or stripping applications. When packings are used, distributors are also used, which have the primary function of uniformly distributing the liquid over the packing so as to optimally use the contact surface provided by the packing as a support for the liquid, while at the same time allowing the gas to pass through the gas passages, which are also referred to as chimneys. Gravity distributors are by far the most widely used.

### FIELD OF THE INVENTION

Use is therefore made of distributors at the liquid inlets, but they are also used from a certain section height, from which the distribution is no longer considered to be uniform enough to provide a satisfactory level of exchange. The liquid is thus collected using an item of equipment referred to as a collector, which subsequently feeds a distributor. When the collector and the distributor are integrated in order to save height, the item of equipment is referred to as a redistributor.

A redistributor makes it possible to uniformly redistribute the liquid flows. However, they also make it possible, to a certain extent, to horizontally homogenize the composition and the temperature of the liquid. This function is sometimes crucial for the column to operate correctly. This is the case in particular for difficult distillations in which the components have very similar boiling temperatures, or else when the aim is to achieve very high purities on one side or the other of the distillation section. In these situations, a maldistribution of the composition has a significant impact on the performance of the column.

In general, it is not necessary to mix all of the liquid in the column at one point. By mixing only a fraction of the liquid, it is possible to achieve virtually complete correction. The difficulty lies in mixing over a long horizontal distance and ideally in both directions of the plane in a reduced height.

Furthermore, it is sought to limit the horizontal speeds at the perforations of the distributors. Specifically, excessively large horizontal speeds are liable to generate flow disparities in each perforation.

### RELATED ART

Devices exist for promoting the mixing of the liquid and therefore the horizontal homogenization thereof. In general, a separate collector and distributor have a better mixing capability. Specifically in the case of a collector, all of the liquid flow is generally directed into a pipe or a small number of pipes. However, the columns that are sensitive to maldistribution are often those that require a large exchange surface and in which vertical compactness becomes a significant challenge.

In order to ensure homogeneity of the flows, it is necessary to have the same hydrostatic head above each perforation. To this end, the most robust solution is to have hydraulic continuity of the liquid seal, via a channel that brings the various distribution zones together. This channel generally passes through the centre of the distributor or occupies the periphery thereof over the entire circumference thereof.

In order to promote the homogenization of the composition relative to standard redistributors, systems of ramps and deflectors are sometimes designed to mix the liquid in the redistributors.

In the case of a distributor with chimneys with rectangular cross sections, mixing in the main direction of the chimneys is easier to promote than in the transverse direction. It is sometimes common practice to alternate the orientation of the distributors in order to mix in both directions of the plane for two successive packed sections. However, this practice introduces an architectural design constraint, in particular for the gas or liquid inlets and outlets.

Redistributors with a mixing function are sometimes produced with an outer ring for collecting the liquid that has accumulated at the wall and hats that direct a fraction of the liquid towards the centre.

More recently, a redistributor-mixer has been designed such that a fraction of the liquid collected on each side of a column is directed to the other end of the column in the direction transverse to the chimneys. Such a device makes it possible to homogenize the composition in a compact redistributor. However, it cannot directly support the packings of the upper section. It is necessary for additional crossbeams to be added thereto. Furthermore, it is more complex to design with multiple weirs to dimension and an upper peripheral channel with a complex form.

### SUMMARY OF THE INVENTION

The invention described herein relates to a simple device for distributing the liquid reflux of a gas-liquid contact column section with good flow homogeneity and mixing of the composition that is improved relative to the prior art, without having an impact on bulk.

Relative to a simple redistributor with basic homogenization as described in Jafari, S. et al. (2017) “CFD study of mixing performance of redistribution systems for packed columns”, hats make it possible to mix the composition in the direction of the troughs and to close off one end of the hat in order to encourage liquid to flow via the other end and optionally to orient them towards the peripheral channel by alternating the orientation or also promote mixing of the compositions over typically three troughs in the transverse direction, while maintaining compactness relative to the solutions in which the collector and the distributor are separate, and with a geometry that is simple to manufacture (number, complexity of the parts and of the assemblies).

The distribution of the liquid over three troughs in the transverse direction is advantageous relative to a redistributor as described in U.S. Pat. Nos. 5,752,538 and 5,132,055.

Moreover, by design, the flows of liquid below the hats are less turbulent than those obtained from troughs formed by deflectors. Specifically, the liquid has just one main flow direction and a larger discharge space including part of the peripheral channel and a portion of the trough.

Although the transverse mixing is inferior to that described in U.S. Pat. No. 11,426,676, the distributor of the present invention is less complex and includes a support for the packing sections without the addition of crossbeams.

Moreover, the hats contribute to the structural rigidity of the distributor by further securing the gas chimneys.

According to one subject of the invention, there is provided a gravity liquid distributor comprising:
a lower plate provided with orifices via which a liquid leaves the distributor in order to irrigate a lower element, such as a lower packing section,
parallel parallelepipedal chimneys dedicated to the passage of the ascending gas, thus delimiting troughs for liquid above the lower plate, these chimneys being provided with closure means on the upper portion, making it possible both to deflect the liquid, which is for example descending from a packing section above the distributor, and preferably to mechanically support this section,
the chimneys are distributed over an entire central portion with a circular cross section of the lower plate, which frees up a peripheral channel, which is fluidically connected to the troughs, over the perimeter of the lower plate,
a plurality of hats that are able to guide the liquid collected above the troughs towards the peripheral channel, each hat having an elongate rectangular form with two ends, wherein:
   here is just one hat per trough, each hat being closed off at just one end and optionally inclined such that at least the majority of the liquid collected flows towards the peripheral channel,
   the hats are oriented at an acute or zero angle with respect to the horizontal, and
   the end of the hats that is closed off alternates from one trough to another.

According to other optional aspects:
at least one of the hats covers at most three-quarters of the surface of the trough,
the distributor comprises a baffle at the outlet of at least one hat and above the perforated plate in order to limit disturbances of the level due to falling liquid for low liquid heights,
some of the hats are located between two adjacent gas chimneys and have a length that is smaller than or equal to that of at least one of the two adjacent gas chimneys,
each hat has a flat bottom, the flat bottom being oriented at an angle of between 0 and 30° with respect to the surface of the plate, or even of between 0° and 10° with respect to the surface of the plate,
the hats are oriented at an acute angle with respect to the horizontal and are alternately oriented towards one side or the other of the plate from one trough to the next,
some of, or even most of, the hats are positioned such that the liquid exits the hats at one end of the two adjacent gas chimneys, so as to discharge the liquid directly into the peripheral channel,
each hat covers at least two-thirds of the surface of the trough and optionally the entire surface of the trough.

According to the invention, there is provided a fluid-contacting column comprising at least one distributor as described above, means for discharging liquid above the distributor and a structured packing section below the distributor.

According to another subject of the invention, there is provided a method for contacting a gas and a liquid in a column as described above.

The column may comprise a structured packing section above the distributor, said section being supported by the closure means.

### BRIEF DESCRIPTION OF THE FIGURES

The invention will be described in more detail with reference to the figures.

FIG. 1 represents a redistributor 1 according to U.S. Pat. No. 5,645,770 with hats R that also serve as closure means for the gas chimneys C placed on a plate P. This solution is relatively simple but does not include the support function for the upper section. It moreover exhibits weak structural rigidity without the addition of parallelepipedal chimneys that pass through the assembly.

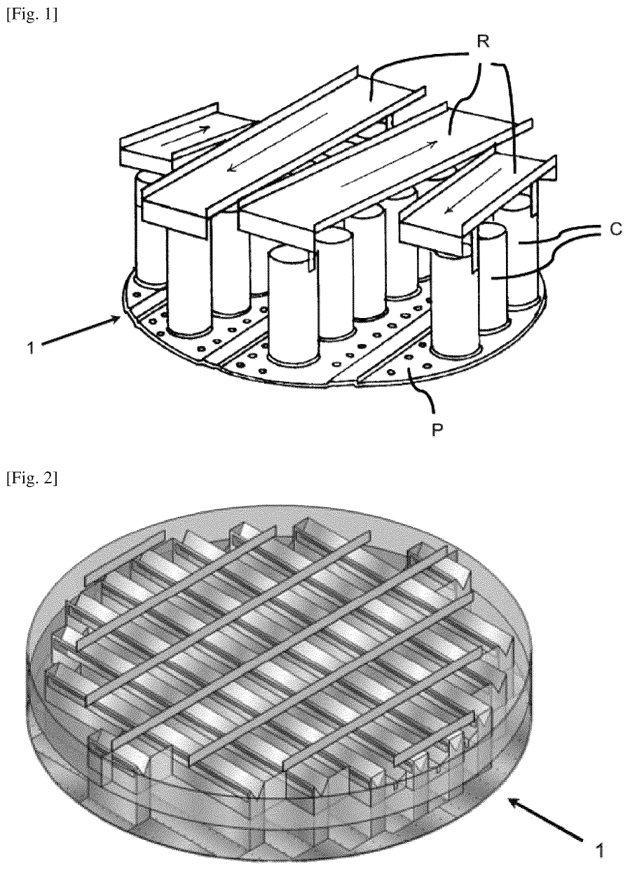

FIG. 2 represents a redistributor 1 according to U.S. Pat. No. 11,426,676. Collecting a fraction of the liquid via the closure means for closing off the gas chimneys and the segmented upper peripheral channel makes fine mixing of the liquid composition possible. However, it is rather complex and crossbeams to be assembled (generally by welding) with the assembly have to be added in order to support the upper section.

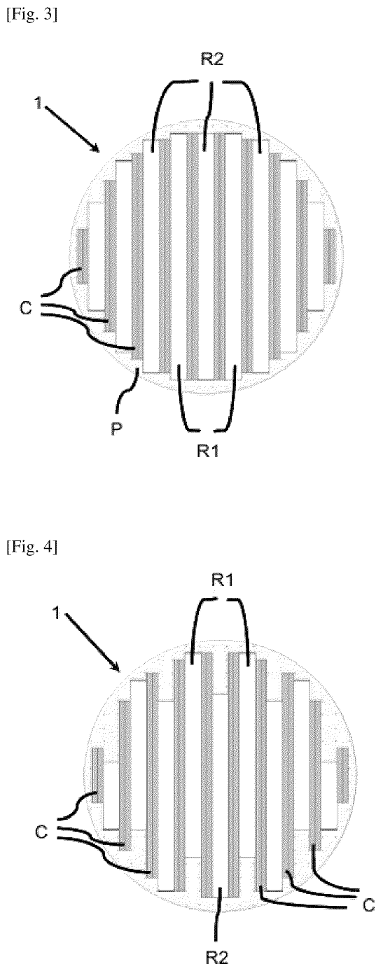

FIG. 3, FIG. 4 and FIG. 5 are top views of a distributor according to the invention.

FIG. 6 and FIG. 7 represent embodiments of the invention viewed from the side.

### DETAILED DESCRIPTION OF THE INVENTION

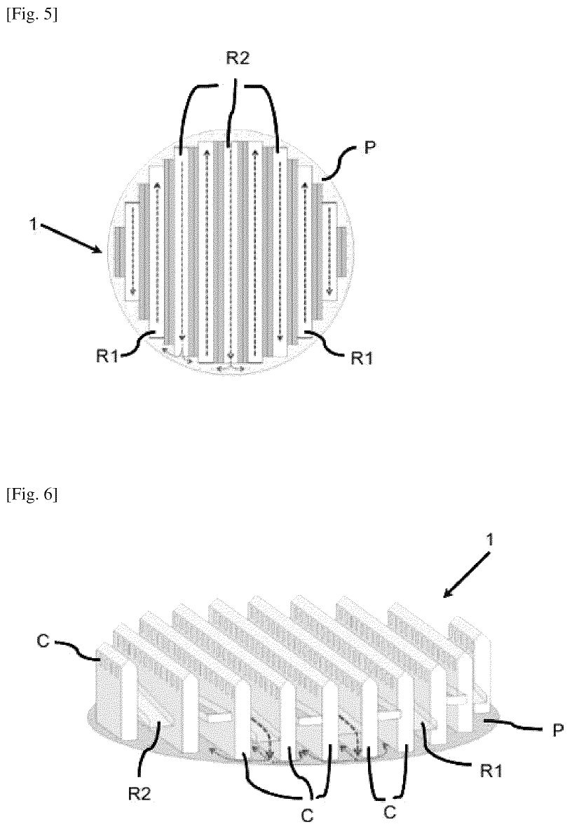

FIG. 3 shows a gravity liquid distributor 1A comprising:
a lower plate P provided with orifices via which the liquid leaves the distributor in order to irrigate a lower packing section,
nine parallel parallelepipedal chimneys C dedicated to the passage of the ascending gas, thus delimiting troughs for liquid above the lower plate, these chimneys C being provided with closure means on the upper portion, making it possible both to deflect the liquid descending from a packing section above the distributor and to mechanically support this section.

The chimneys C are distributed over the entire central portion of the lower plate P, which frees up a peripheral channel P over the perimeter of the lower plate, which places in continuity a plurality of hats R that guide the liquid collected above the troughs towards the peripheral channel P.

There is just one hat R per trough, the hat being inclined (as illustrated) and/or closed off at just one end such that the majority of the liquid collected flows towards the peripheral channel.

The ends that are closed off alternate from one trough to another, so that if a hat in one trough has its left-hand end closed off, the hats of the adjacent troughs will have their right-hand end closed off, and vice versa. Thus, the hats discharge the liquid in a balanced manner onto the peripheral channel.

The hat may be horizontal or be at an acute angle of less than 30° C., or even than 10° C., with respect to the horizontal, the plate P being oriented horizontally.

In this example, the hats R1, R2 are oriented at an acute angle with respect to the horizontal and are alternately oriented towards one side or the other of the plate from one trough to the next. The hats R1, R1 therefore have alternating gradients. Thus, the four hats R1 are oriented with their lowest end towards one edge of the plate and the five hats R2 are oriented with their lowest end towards the opposite edge.

One single hat R1, R1 covers at most the entire surface of the trough, but preferably only over a fraction, for example at least two-thirds of the surface of the trough.

Optionally, baffles may be arranged at the end at which the liquid exits the hats and above the perforated plate in order to limit disturbances of the level due to falling liquid for low liquid heights.

In the variant in FIG. 3, the hats have a length that is shorter than one adjacent chimney and longer than the other adjacent chimney, except for the central hat, which has the same length as the two adjacent chimneys.

In the variant in FIG. 4, the three central hats are shorter than the adjacent chimneys.

The hats are preferably in contact with the vertical walls of the chimneys.

The dotted arrows in FIG. 5 describe the path of the liquid leaving the hats and being distributed via the peripheral channel in three connected troughs from FIG. 3.

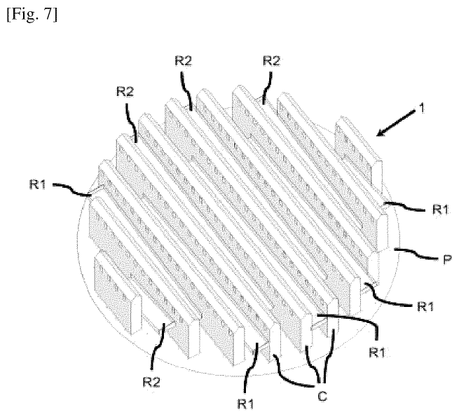

In FIG. 6, it can be seen that the top end of each hat according to FIG. 4 is obstructed in order to avoid the liquid discharging on the wrong side. The top of the chimney C is pierced by multiple openings in order to allow the gas rising in the column to pass.

In FIG. 7, the version from FIG. 5 can be seen from the side.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A gravity liquid distributor comprising:
a lower plate (P) provided with orifices via which a liquid leaves the distributor in order to irrigate a lower element, such as a lower packing section,
parallel parallelepipedal chimneys (C) dedicated to the passage of the ascending gas, thus delimiting troughs for liquid above the lower plate, the parallel parallelepipedal chimneys being provided with a closure means on the upper portion, configured both to deflect the liquid, and to mechanically support this section,
the parallel parallelepipedal chimneys are distributed over an entire central portion with a circular cross section of the lower plate, which frees up a peripheral channel, which is fluidically connected to the troughs, over the perimeter of the lower plate,
a plurality of hats (R, R1, R2) that are configured to guide the liquid collected above the troughs towards the peripheral channel, each hat having an elongate rectangular form with two ends, wherein:
there is just one hat per trough, each hat being closed off at just one end and optionally inclined such that at least the majority of the liquid collected flows towards the peripheral channel,
the hats are oriented at an acute or zero angle with respect to the horizontal, and
the end of the hats that is closed off alternates from one trough to another.

2. The distributor according to claim 1, wherein at least one of the hats (R, R1, R2) covers at most three-quarters of the surface of the trough.

3. The distributor according to claim 1, comprising a baffle at the outlet of at least one hat (R, R1, R2) and above the perforated plate (P) in order to limit disturbances of the level due to falling liquid for low liquid heights.

4. The distributor according to claim 1, wherein some of the hats (R, R1, R2) are located between two adjacent parallel parallelepipedal chimneys (C) and have a length that is smaller than or equal to that of at least one of the two adjacent parallel parallelepipedal chimneys.

5. The distributor according to claim 1, wherein each hat (R, R1, R2) has a flat bottom, the flat bottom being oriented at an angle of between 0 and 30° with respect to the surface of the plate (P) with respect to the surface of the plate.

6. The distributor according to claim 5, wherein the hats (R, R1, R2) are oriented at an acute angle with respect to the horizontal and are alternately oriented towards one side or the other of the plate (P) from one trough to the next.

7. The distributor according to claim 1, wherein some of, or even most of, the hats are positioned such that the liquid exits the hats at one end of the two adjacent parallel parallelepipedal chimneys, so as to discharge the liquid directly into the peripheral channel.

8. The distributor according to claim 1, wherein each hat (R, R1, R2) covers at least two-thirds of the surface of the trough.

9. A fluid-contacting column comprising at least one distributor according to claim 1, a means for discharging liquid above the distributor and a structured packing section below the distributor.

10. The column according to claim 9 comprising a structured packing section above the distributor, said section being supported by the closure means.

11. A method for contacting a gas and a liquid in a column according to claim 9.
